(19) United States
(12) Patent Application Publication
(10) Pub. No.: US 2021/0315222 A1
(43) Pub. Date: Oct. 14, 2021

(54) PROCESS FOR PRODUCING A FERMENTED LIQUID

(71) Applicant: L'Air Liquide, Societe Anonyme pour l'Etude et l'Exploitation des Procedes Georges Claude, Paris (FR)

(72) Inventors: Philippe CAMPO, Paris (FR); Dominique IBARRA, Paris (FR)

(73) Assignee: L'Air Liquide, Societe Anonyme pour l'Etude et l'Exploitation des Procedes Georges Claude, Paris (FR)

(21) Appl. No.: 17/267,736

(22) PCT Filed: Aug. 9, 2019
(86) PCT No.: PCT/EP2019/071390

§ 371 Date: Feb. 10, 2021

(30) Foreign Application Priority Data
Aug. 10, 2018 (FR) FR 1857436

(51) Int. Cl. A23C 9/13; A23C 9/12

(52) U.S. Cl. CPC A23C 9/1307; A23C 2240/20; A23C 9/122

(57) ABSTRACT

A process for producing a fermented liquid food product includes the following steps. A liquid is pasteurized. The liquid is completely or partially cooled. The liquid arrives in a tank. Ferments are added to the liquid in the tank. Before the liquid arrives in the tank, the tank is inerted through flushing a headspace of the tank with an inert gas.

### CROSS-REFERENCE TO RELATED APPLICATIONS

This application is a § 371 of International PCT Application PCT/EP2019/071390, filed Aug. 9, 2019, which claims § 119(a) foreign priority to French patent application FR 1857436, filed Aug. 10, 2018.

### BACKGROUND

### Field of the Invention

The present invention relates to the food industry and in particular to the milk industry but more generally the invention is targeted at liquids which will be fermented, in particular by lactic acid bacteria. This is the case with milk, to which bacteria are added in order to produce yoghurt, cheese, and the like, but this can also be the case with soya milk, for example.

### Related Art

The advantage of maintaining, in the milk used to make yoghurts, an amount of dissolved O₂ which is low, as low as possible, with the aim of lowering the latency time of the lactic acid bacteria and thus of shortening the production time, has been reported in the literature of this technical field.

It is appropriate to recall in what follows the concepts which are involved here.

Lactic acid fermentation is the process by which lactic acid bacteria grow, under anaerobic conditions, producing lactic acid from the carbohydrates present in the product which is fermented (lactose in the case of milk).

Lactic acid bacteria, which include, for example, lactobacilli, streptococci, bifidobacteria, leuconostocci and enterococci, are anaerobic bacteria, partially tolerant to oxygen.

The growth curve of the bacteria during lactic acid fermentation is the same as for any other fermentation and comprises:
A lag phase: during this phase, the growth rate is zero or virtually zero. This is the time required for the bacteria to adapt to the composition of the substrate (medium in which the fermentation takes place) and to produce the enzymes necessary for its use. The duration of the lag phase thus depends on the composition of the fermentation medium.
An acceleration phase.
An exponential growth phase: the bacteria doubling time is short and the growth time is thus at its maximum.
A slowing down phase.
A stationary phase: the growth rate becomes zero, the bacteria which multiply compensate for those which die.

A lever for improving the productivity of lactic acid fermentation is to reduce the lag phase. In particular, it has been proven that a low level of dissolved oxygen in milk at the start of fermentation makes it possible to reduce the duration of the lag phase. This is because the oxygen dissolved in milk would delay the production of lactic acid.

The literature in this field has in particular shown the following points:
it is known to carry out the deoxygenation or deaeration of milk by a process based on placing the product under total or partial vacuum. By way of example, mention may be made of the U.S. Pat. No. 2,151,644, which proposes a method for deaerating a liquid foodstuff by continuously circulating a liquid in the form of a film in a vacuum chamber.

However, vacuum degassing exhibits the following disadvantages:
A significant capital cost,
A high energy consumption,
Losses of flavorings,
Collapsing of packaging,
Possible problems of loss of asepsis.
Vacuum degassing will protect the product from oxidation just before the pasteurization step, but nothing is done after this step, the product will then inevitably take up oxygen (via the air) during the following steps of the process.
it is also known to carry out a deoxygenation of milk with nitrogen: by way of illustration, the document FR-2 964 884 on behalf of the applicant company proposes a process for the in-line deoxygenation of a liquid food or pharmaceutical during which the liquid to be deoxygenated undergoes, in the pipe, an injection of a neutral gas of nitrogen type, followed by a step of separation of the gas (loaded with oxygen) and of the liquid. A gas/liquid separation step is thus present here.

While the preceding example describes an in-line injection, copious literature furthermore proposes to carry out a deoxygenation in “batch” mode, but “batch” deoxygenation, in addition to exhibiting the same disadvantages as in-line deoxygenation, represents an amount of gas consumed per amount of liquid treated which is high. Furthermore, “batch” deaeration, that is to say the injection of a neutral gas by diffusion or agitation of the liquid, requires in this case one more step in the process, a step which will consume time, knowing that the objective is to save time on the latency step at the start of the fermentation. In conclusion, to add a “batch” deoxygenation step will in all probability have the opposite effect to that expected on the productivity.

Furthermore, it is not always possible to ensure permanent agitation or bubbling of the liquid. This is because the milk is often fermented for the production of yoghurt or cheese, and the fermentation step makes possible the formation of a gel, the texture of which is important for the quality of the final product. If agitation or bubbling disturbs the formation of the gel, the product obtained will not have the desired texture.

On the other hand, the injection of a gas into milk is limited by the formation of foam which causes processing difficulties as well as cleaning difficulties, and product losses. Finally, foaming can detrimentally affect the state of the milk proteins.

### SUMMARY OF THE INVENTION

One of the objectives of the present invention is therefore to provide a new fermentation process exhibiting better productivity than a conventional process because it employs a fermentation medium having a level of dissolved oxygen which is zero or virtually zero, without the need for a step of deoxygenation with vacuum or with nitrogen as according to the prior art.

As will be seen in more detail in what follows, the present invention proposes to work under the following conditions, where the liquid, for example milk, but the targeted “liquid” can also be a mixture, for example a mixture for the production of a yoghurt, undergoes in particular the following steps:
The pasteurization of the milk;
Its cooling;
According to one of the preferred embodiments of the invention, an injection into the line, downstream or upstream of the pasteurization, of a small amount of nitrogen in order to rebalance the milk with nitrogen. For example, the injection of a flow of nitrogen (nitrogen or another gas, including CO₂) of between 5 and 50 g per cubic meter of liquid, preferentially between 10 and 30 g/m³, in order to bring the liquid to a condition of balance after it has cooled following the pasteurization;
The arrival of the pasteurized milk after cooling or for its cooling step preferentially in a tank, via the bottom of the tank or via the top of the tank, the tank having been inerted beforehand, for example by flushing the headspace of the tank using a neutral gas, such as nitrogen, containing or not containing CO₂.
The inoculation of the milk in this tank by lactic acid bacteria, preferentially under inerted conditions, because the inoculation is accompanied by agitation to homogenize the mixture, which promotes a possible reincorporation of air.

According to one of the embodiments of the invention, a small amount of CO₂ (or a gas comprising CO₂), for example an amount of between 20 and 1500 mg/l, preferentially an amount of between 150 and 900 mg/l, can be injected into (dissolved in) the liquid: in line (before its arrival in the tank) or in an upstream vessel, in order to prelower the pH thereof and to thus further reduce the fermentation time. This is because fermenting a liquid amounts to lowering its pH by the action of bacteria, which produce lactic acid. Thus, for example, during the fermentation of milk for the production of yoghurt, the pH falls with the growth of lactic acid bacteria; when the pH reaches 4.6 (isoelectric pH of caseins, major proteins of milk), the milk curdles, forming a gel. If CO₂ is added, the pH falls a little faster, supporting the work of the bacteria.

This small amount of dissolved CO₂ will also have the advantage of more effectively protecting the milk from a possible uptake of oxygen via air during transfers into partially inerted containers.

In the case of certain liquids to be fermented (for example yoghurts), which are not “simple” milk, liquids which result from the mixing of several liquid and possibly solid ingredients, for example considering the case of a yoghurt, the liquid which will be fermented, and which will thus pass through the pasteurizer before inoculation, is a mixture of milk, milk protein powder, optionally sugar, optionally cream, and the like. It is then very advantageous, in the context of the present invention, for the mixing of these ingredients to be carried out under inerting in order, on the one hand, to remove the dissolved oxygen present in the ingredients and, on the other hand, to avoid the incorporation of oxygen due to the very action of mixing.

The main advantages of the technical proposal according to the present invention can be summarized thus:
No uptake of oxygen
No need for a gas/liquid separation step
No step added to the process (the protection and the balancing of the liquid with nitrogen are carried out during the step of transfer of the product to the receiving vessel located after the pasteurization).
No foam formation
A saving in production time
A reduced gas consumption compared to the other solutions of the prior art.

Unlike the prior art touched on above in the present description, the present invention takes advantage of the fact that the residual oxygen in the liquid, for example milk, on leaving pasteurization is very low and that the tank is inerted BEFORE the arrival of the liquid. Thus, according to the present invention, deoxygenation is not carried out, uptake of oxygen is avoided, which consumes less gas, and that, by the fact that the inerting takes place in parallel with the pasteurization, a time for an additional step is not added.

### BRIEF DESCRIPTION OF THE FIGURES

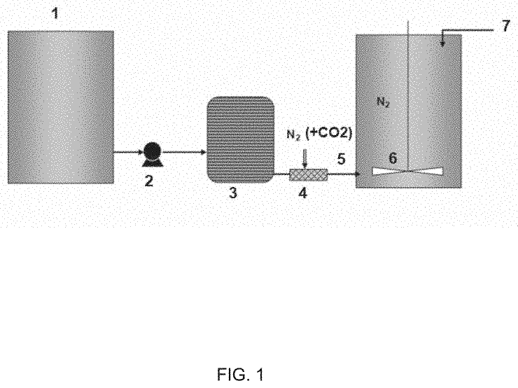

The appended FIG. 1 illustrates a partial diagrammatic view of a plant suitable for the implementation of the invention.

### DETAILED DESCRIPTION OF THE INVENTION

The following plant elements can be recognized in the FIGURE:
As reference 1: a milk storage vessel
As 2: a pump
As 3: a pasteurizer
As 4: an in-line gas injector (for example a Venturi system)
As 5: an inlet for the liquid via the bottom in the fermentation tank (10), which has been preinerted with nitrogen
6: a mixing shaft
7: an inlet for ferments

The present invention consequently relates to a process for the production of a fermented liquid food, comprising the following steps:
the pasteurization of the liquid;
its cooling in all or part;
its arrival in a tank;
the inoculation of the liquid contained in the tank by ferments, for example by lactic acid bacteria,

characterized in that the tank was, before the arrival of the liquid, inerted beforehand, for example by flushing the headspace of the tank using a neutral gas, such as nitrogen, containing or not containing CO₂.

An inerting by flushing using a gas is touched on above but other methods can be envisaged, and in particular the use of the low pressure created during the aseptic cleaning of the tank and the injection of an inert gas, such as nitrogen, to compensate for the low pressure.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-5. (canceled)

6. A process for the production of a fermented liquid food, comprising the steps of:
pasteurizing the liquid;
cooling all or part of the liquid;
arrival of the liquid in a tank;
inoculating the liquid in the tank by ferments, wherein, before arrival of the liquid in the tank, the tank is inerted by flushing a headspace of the tank with a neutral gas that comprises nitrogen and optionally CO₂.

7. The process of claim 6, wherein before arrival of the liquid in the tank and either downstream or upstream of the pasteurization, the neutral gas is injected in-line into the liquid at a flow rate of between 5 and 50 g per cubic meter of liquid.

8. The process of claim 6, wherein before arrival of the liquid in the tank and either downstream or upstream of the pasteurization, the neutral gas is injected in-line into the liquid at a flow rate of between 10 and 30 g per cubic meter of liquid.

9. The process of claim 6, wherein CO₂ or a gas containing CO₂ is injected into the liquid, for example in-line, before its arrival in the tank or else into the actual tank, preferentially in an amount of between 20 and 1500 mg/l and more preferentially of between 150 and 900 mg/l.

10. The process of claim 6, wherein said liquid is milk.

11. The process of claim 6, wherein:
said liquid is a mixture of several liquid ingredients, and optionally solid ingredients; and
mixing of the ingredients, to form the mixture, is carried out under inert conditions.

12. The process of claim 6, wherein the ferments are lactic acid bacteria.
